(19) United States
(12) Patent Application Publication
(10) Pub. No.: US 2006/0055125 A1
(43) Pub. Date: Mar. 16, 2006

(54) Quick-clamping device with hub centering ring for securing a vehicle wheel on the shaft of wheel-balancing machines

(76) Inventor: Axel Ohnesorge, Burgwedel (DE)

Correspondence Address: SHLESINGER, ARKWRIGHT & GARVEY LLP, 1420 KING STREET, SUITE 600, ALEXANDRIA, VA, 22314, US

(21) Appl. No.: 11/221,740

(22) Filed: Sep. 9, 2005

(30) Foreign Application Priority Data
Sep. 10, 2004 (DE) 10 2004 044 287.8

(51) Int. Cl. B23B 31/40

(52) U.S. Cl. 279/2.12

(57) ABSTRACT

Quick-clamping device with a hub centering ring secures a vehicle wheel rim on the shaft of a wheel-balancing machine. Securely attached to the shaft is a flange to facilitate a friction fit placement on the rim. For centering, a conical assembly is provided, including an inner bore to be slid onto the shaft of the balancing machine, as well as an outer centering surface for engaging the centering hole of the rim. Conical assembly includes a cone, from the apex of which a tubular element extends, and which is mounted with its inner wall axially displaceable on the shaft or an extension of it, and a clamping element for tightening the rim against the flange abuts its outer wall. Advantageously, until reaching the centering and clamping position by using the clamping element, quick-clamping device ensures no forces must be overcome. This provides ease of use of the quick-clamping device.

### CROSS REFERENCE TO RELATED APPLICATIONS

This application claims the priority of German Application No. 10 2004 044 287.8, filed Sep. 10, 2004, which is incorporated herein by reference.

### FIELD OF THE INVENTION

The invention relates to a clamping device for fixing a wheel rim of a vehicle wheel to a shaft of a balancing machine. More particularly, the invention relates to a quick-clamping device for securing a vehicle wheel to a shaft of a balancing machine. Even more particularly, the invention relates to a quick-clamping device for adjustably, fixedly securing a vehicle wheel rim to a centering shaft of a wheel balancing machine with little effort.

### BACKGROUND OF THE INVENTION

DE 38 08 755 C2 describes a quick-clamping device in which the conical assembly is pressed into the centering hole of the vehicle wheel rim by a spring exerting force axially. The spring travel is determined so that for rim centering holes of different diameters the conical assembly engages the centering hole of a rim with its outer centering surface. As a result of this, the spring must always be compressed more or less axially during tightening of the rim against the flange. This spring force must therefore be overcome with the clamping element. This is laborious and particularly demanding, if the clamping element is a clamping nut, which is screwed by hand onto the outer threads of the shaft. In this case, not only the spring force, but moreover the friction force resulting from the contact between the spring and the threads, must also be overcome.

DE-OS 23 61 847 describes a device for centering ring-shaped objects around a spindle, which features a truncated cylinder-shaped part, which in turn features both a central bore for mounting the truncated cylinder-shaped part onto the spindle as well as radial slots. The truncated cylinder-shaped part features on its axially tapered end a cylindrical protrusion, on which a cup-shaped part is mounted so that it can be clamped displaceably on the axis of the truncated cylinder-shaped part. To secure a centering object, the truncated cone-shaped part must first be pulled outward after the clamping nut is released and, after the object to be centered is introduced, must then be pushed forward again with its central hole on the truncated cone-shaped part, so that the cup-shaped part is clamped against the truncated cone-shaped part and so the central hole of the object to be centered is centered on the outer surface of the truncated cone-shaped part, wherein at the same time the slotted truncated-cone shaped part, owing to its slots, is clamped with its inner bore against the spindle. Through a clamping procedure the object to be centered is secured to the truncated cone-shaped part, which is in turn secured to the spindle at the same time. This device of the prior art is tedious to use, since the truncated-cone-shaped and cup-shaped parts must first be separated and then, after the object to be centered has been mounted, must then be brought back together, before clamping can be performed. A further disadvantage can be found in the fact that when clamping a vehicle wheel the contact edge of the cup-shaped part makes contact with the side of the vehicle rim facing away from the truncated-cone-shaped part, with which the rim does not make contact on the securing flange of the axle when it is mounted on the vehicle. A dynamic balancing of the vehicle wheel is therefore not possible. The decisive disadvantage, however, can be found in the fact that following clamping the axial position of the device is not set, therefore making this prior art device unsuitable for clamping a vehicle wheel onto the shaft of a balancing machine.

DE 195 11 405 A1 describes a clamping device for use in clamping vehicle wheels to a shaft of a balancing machine, wherein the conical assembly is pressed into the center hole by a spring exerting force axially. This prior art device therefore has the same disadvantages as those of the device proposed in DE 38 06 755 C2 mentioned above.

As in the previous devices, the device proposed in DE 42 00 380 A1, features a centering cone pressed into the centering hole by spring force. The same is true of the device proposed in DE 28 13 387 A1.

DE 36 05 821 A1 describes a quick-action clamping nut for use in clamping the rim of a vehicle wheel to shaft of balancing machine, wherein an end of the shaft features outer threads. The quick clamping property is thereby realized through the fact that the threads are located in two radially movable jaws, so that the threads can be engaged and disengaged through the movement of the jaws. This quick-clamping nut of the prior art does not feature a centering cone.

### OBJECTS AND SUMMARY OF THE INVENTION

An object of the present invention is to create a quick clamping device for securing vehicle wheels to a wheel balancing machine, and in which the disadvantages of the prior art quick clamping devices are avoided and, in particular, the securing of the rim to the flange is simplified.

This object of the invention has been solved through the teachings in accordance with the invention set forth below.

A fundamental teaching in accordance with the invention includes that the engagement of the conical assembly with the centering hole of a vehicle rim no longer needs to be effected by use of a spring, but can instead be realized by use of the forces resulting from the tightening of the rim against the flange. To this end, the inventive clamping device to be used for securing the rim against the flange abuts a tubular component, which is connected to the conical assembly and is disposed on the shaft of the wheel balancing machine in such a way that it is axially displaceable thereon. When the clamping device or element is secured, the forces of the clamping device or element are then transmitted to the conical assembly and are centered by this component on the inner wall of the centering hole of the vehicle rim. Overall, only the required force for securing the rim against the flange must be overcome by the clamping device or element. The tightening travel is therefore as small as possible, as is the work required for such securing.

The invention likewise includes that an outer wall of a tubular component according to the invention includes outer threads, onto which the clamping nut, in particular a quick-clamping nut, can be screwed. With the exception of minor friction forces in the threads, essentially no other forces are required when the clamping nut is being screwed into position. Centering can be accomplished with practically no output of force, with force being necessary only for securing the rim against the flange.

Because the conical assembly is displaceable in relation to the inventive tubular component extending from its tip, the conical assembly can be placed in various axial positions, before the centering hole of a rim is introduced and the conical assembly is driven into the centering hole. If wheels with centering holes of the same diameter are clamped, the conical assembly has the same axial position in the centering position. For this reason, it is advantageous according to a further embodiment of the invention to feature an adjustment device or element with which the axial position of the conical assembly can be adjusted, that is, preset in relation to the constant diameter of the centering holes.

According to a further development of this embodiment of the invention, the inventive adjustment element includes a threaded spindle, which extends within the tubular part and abuts the shaft of the balancing machine, or a part connected thereto, with one end and engages the threads of a supporting piece, which is securely connected to the tubular component, wherein a turning knob is provided on a part extending axially from the supporting piece of the threaded spindle, wherein the knob can be employed also through different means to facilitate the turning of the threaded spindle.

It is advantageous if the inventive adjusting device or element can also be realized as an arresting device or element or locking element, through the assistance of which the conical assembly can be adjusted to various displacement settings. The arresting element can be realized in many different ways. It is advantageous if the arresting element includes an axially spring-loaded ball or similar component at the shaft or a component connected thereto, whereby the ball or similar component is present opposite the arrest recess in the tubular component. In a similar realization of the adjusting device or element, it is also possible after introducing a vehicle wheel to manually bring the tubular component so far forward axially, that the conical assembly is centered in and engages the centering hole of the rim of the vehicle. This setting results in the ball being arrested in an opposite lying recess, so that this position of the conical assembly remains locked for subsequent clamping involving rims with centering holes of equal diameter. The conical assembly can be manually adjusted to another arresting position, and thereby centering position, by hand when being used on wheels with centering holes of various diameters.

It is advantageous if it can be ensured that rotation of the conical assembly in relation to the shaft or an extension thereof is restricted in accordance with the invention.

The conical assembly can be realized very simply as a cone, which is moved into the centering hole of a vehicle rim during centering and thereby facilitating actual centering with its conical outer surface. It is especially advantageous, however, if in a further embodiment of the invention the conical assembly includes an outer central portion with a cylindrical outer surface for engaging the centering hole of the vehicle rim and includes a conical inner surface which the cone of the conical assembly engages with its conical outer surface, whereby the centering part comprises radially movable segments separated from one another. Centering can also be facilitated through the movement between the conical surfaces of the cone and the segments of the outer centering portion, which has the advantage that these surfaces can be slid over each other with a high degree of precision. The position of the cylindrical outer surface of the centering part in relation to the conical surface is also very exact, and, owing to the cylindrical form facilitates a securely centered positioning in the inner edge of the centering hole of a rim.

In a further development of this embodiment of the invention, the segments also feature radially extending guides, which are radially displaceable in the guides extending radially in the flange. The form of guides can be realized according to preference. For example, they can be rods, which are introduced into radial bore. In an advantageous further development of this embodiment according to the invention, the guide parts feature the form of radial flanges, which are inserted into radially running slots, and which are preferably found on the flange for receiving the vehicle rim. In an advantageous configuration, the segments are drawn radially inward by a spring device or element, so that a clearance-free positioning on the cone is ensured. It is advantageous if the spring element or biasing element is a ring, preferably a rubber ring, which runs in a peripheral groove of the segment.

Embodiments of the invention are explained in further detail below with reference being made to the drawings.

Relative terms such as right, left, up and down are for convenience only and are not intended to be limiting.

### BRIEF DESCRIPTION OF THE DRAWINGS

FIG. 1 shows a cross section of an embodiment of the invention;

FIG. 2 shows the embodiment of FIG. 1 attached to a clamping nut;

FIG. 3 shows a modification of the embodiment of FIG. 1;

FIG. 4 shows another modification of the embodiment of FIG. 1; and

FIG. 5 shows an enlarged section taken from FIG. 4.

### DETAILED DESCRIPTION OF THE INVENTION

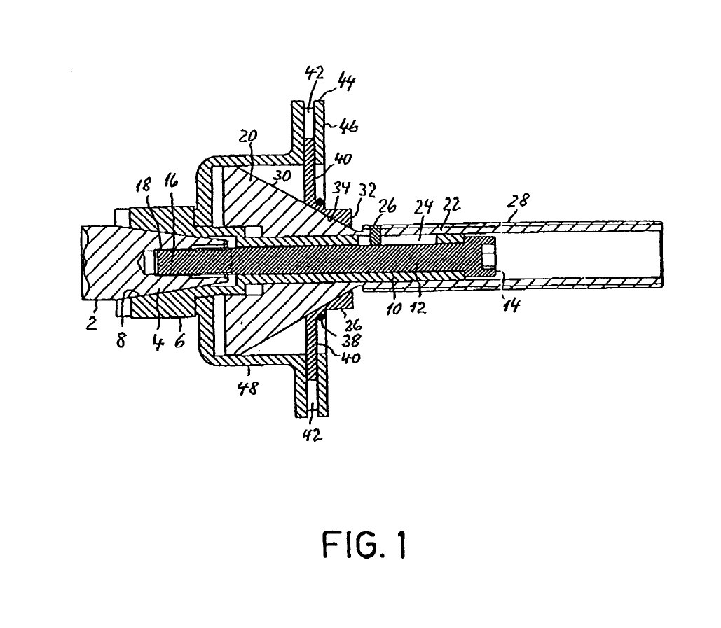

FIG. 1 shows the end of the shaft 2 of an unillustrated wheel balancing machine. Disposed on a conical section 4 of the shaft 2 is an extending part 6 with a complementary conical inner bore 8. The extension of the extending part 6 essentially comprises an axially extending tubular part 10, in which a screw 12 extends, and which is provided with its head 14 at the end of the tubular part 10 and is screwed into a threaded hole in the conical part 4 with its threads facing away from the head 14 so that the extending part 6 is securely mounted on the conical part 4.

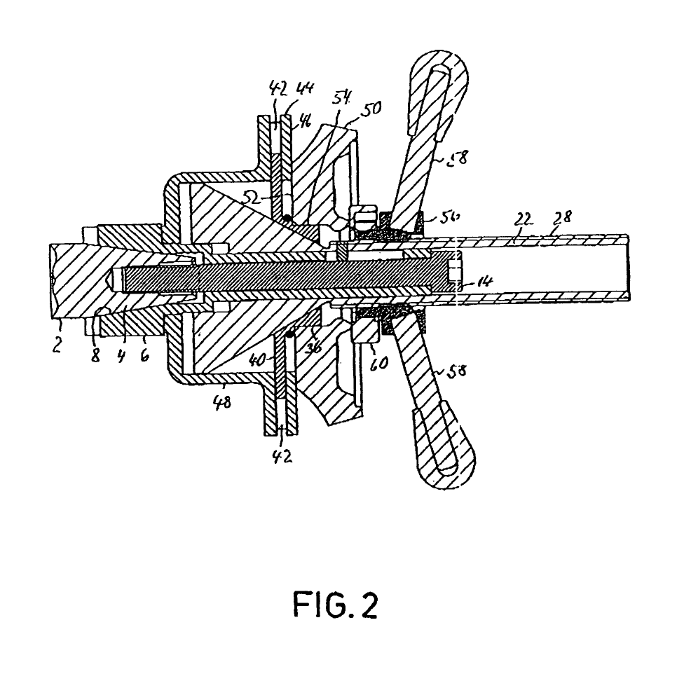

A cone 20 is mounted axially displaceable on the tubular part 10 with narrow clearance. Extending from its point is a tubular element 22, which is formed from the same piece as the cone 20 and, like the cone, is axially displaceable on the tubular part. Extending over a defined length in the tubular part 10 is a groove 24, in which the rod 26 provided in the tubular element 22 is displaceably engaged, thereby preventing rotating of the tubular element 22 in relation to the tubular part 10. On the outer wall of the tube 22 are outer threads 28 onto which a clamping screw can be screwed, as shall be explained below with reference drawn to FIG. 2.

On a conical outer surface 30 of the cone 20 segments 32 with complementing conical inner surfaces are provided and form an outer centering part with a cylindrical outer surface 36 for centering and engaging a centering hole of a vehicle rim. A rubber ring 38 holds the segments 32 with their conical inner surfaces 34 in position with the conical outer surface 30 of the cone 20. Each segment 32 includes a radially extending flange section 40, which is radially displaceable in the radial slots 42 of a flange 44. The flange 44 includes a contact surface for the rim of a clamped vehicle wheel and is connected via a cup 48 to the extending part 6 and thereby with the shaft 2.

FIG. 2 shows the quick-clamping device in accordance with FIG. 1 and in the same perspective, yet supplemented by a partly illustrated rim 50 of a vehicle wheel. A surface 52 of the rim 50 makes contact with the contact surface 46 of the flange 44, while at the same time the cylindrical outer surface 36 of the segment 32 makes contact with an inner surface 54 of a centering hole of the rim 50. With the aid of a hand grip 58 a clamping nut 56 is screwed onto the outer threads 28 so that the clamping nut presses against the rim 50 through an intermediate ring 60. The force of the pressure causes the tubular element 22 and thereby also the cone 20 to be shifted to the right in the drawing so that the conical outer surface 30 and the segments press radially outward, so that the cylindrical outer surface 36 of the segments 32 are centered in relation to the inner surface 54 of the rim.

To clamp the rim 50, the inner surface 54 of the rim 50 of the vehicle wheel is first placed on the cylindrical outer surface 36 of the segment, wherein the cylindrical outer surface 36 still has a smaller diameter than that of the inner surface 54 of the centering hole of the rim owing to the strength of the rubber ring 38. The clamping nut 56 is then screwed on, wherein virtually no screwing force is required, until the intermediary ring of the clamping nut 56 makes contact with the rim 50, the surface of which is tightened against the contact surface 46 of the flange 44. When using a quick-clamping nut, it is not necessary to first engage the inner threads with the outer threads 28 immediately after mounting the nut on the tubular element 22. Instead, the tubular element 22 can first be shifted manually to the right in the drawing to partly complete the centering. The quick clamping nut is brought via its intermediary ring 60 into contact with the rim 50, before its inner threads are then engaged with the outer threads 28 and tightened.

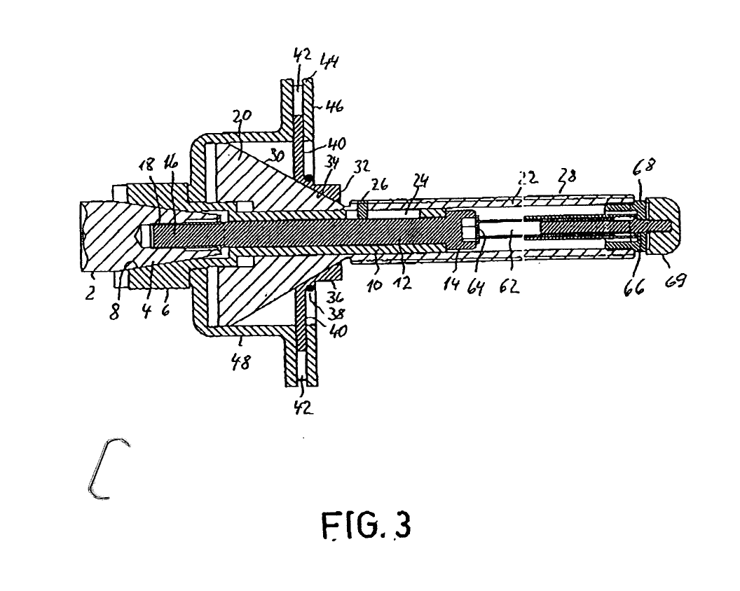

FIG. 3 shows a modification of the embodiment of FIG. 1. Like elements are given the same reference numbers. The difference is that a threaded spindle 62 is provided, an end 64 of which makes contact with the head 14 of the screw 12, while its other end engages the inner threads 66 of a supporting piece 68, which is securely connected with the tubular element 22. On an end of the threaded spindle 62 extending axially from the support piece 58 is a rotary knob 69 with the aid of which the threaded spindle can be turned, thereby allowing the position of the tubular element 22 and therefore the cone 20 to be preset axially, to allow the diameter of the cylindrical outer surface 36 of segment 32 to be adjusted to the same diameter of the centering holes of wheels to be balanced so that the travel of the clamping nut 56 can remain small.

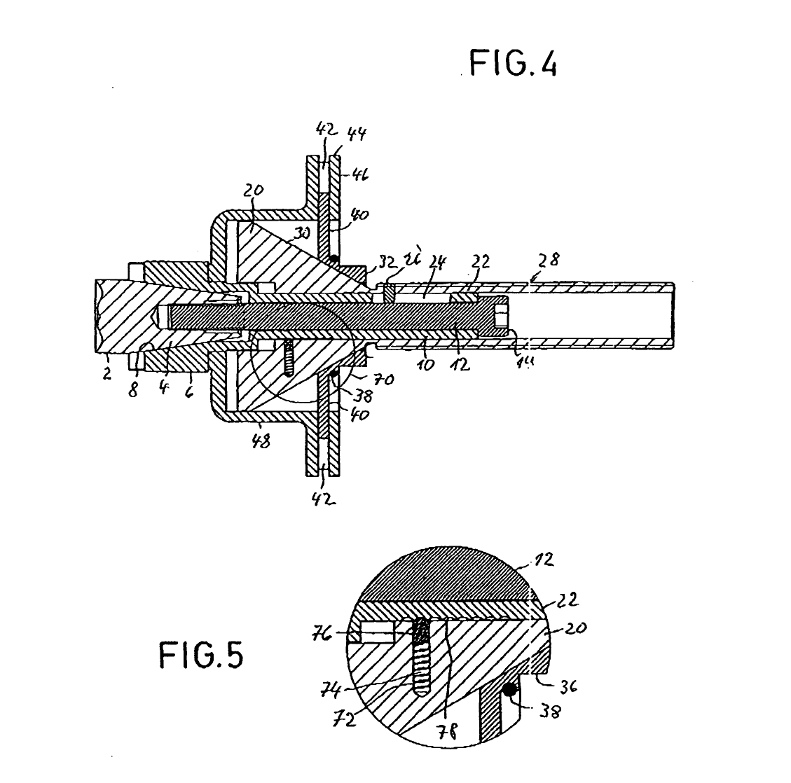

FIG. 4 shows a further modification of the embodiment of FIG. 1. Like elements are given the same reference numbers. The difference is evident in the fact that for adjusting the tubular element 22 and thereby the cone an arresting device or element is provided. For clarity an enlarged detail of a section demarcated by a circle 70 is provided in FIG. 5. From FIG. 5, it is evident that the cone 20 includes a tapped blind hole 72, in which a coil spring 74 is provided, and which presses a rod 76 with a spherical end into corresponding arrest recesses 78 in the tubular element 22. If the cone 20 is shifted, the spherical end of the rod 76 can be arrested in various arrest recesses, thereby allowing the cone 20 to be locked in various displacement positions to adjust the diameter of the cylindrical outer surface 36 of the segment 32 to different diameters of rim centering holes.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. A quick-clamping device for securing a vehicle rim to a shaft of a wheel balancing machine, comprising:
a) a hub centering ring for securing a vehicle rim to the shaft of a wheel balancing machine;
b) a flange configured for being secured on the shaft of a wheel balancing machine to facilitate a friction fit with a rim of a vehicle wheel;
c) a clamping element configured for tightening a rim against the flange;
d) a conical assembly, the conical assembly including:
i) an inner bore configured to be slid onto the shaft of a wheel balancing machine;
ii) an outer centering surface configured to engage a centering hole of a rim of a vehicle wheel; and
iii) the conical assembly including a cone having a tip and a tubular element extending from its tip, and being axially displaceable with its inner wall along the shaft, and having an outer wall abutting the clamping element for securing the rim of a vehicle against the flange.

2. Quick-clamping device as in claim 1, wherein:
a) the outer wall of the tubular element includes outer threads, and the clamping element includes a clamping nut.

3. Quick-clamping device as in claim 1, wherein:
a) an adjustment element is provided with which the axial position of the conical assembly can be adjusted.

4. Quick-clamping device as in claim 3, wherein:
a) the adjustment element includes a threaded spindle, which extends within the tubular element, and abuts the shaft of a wheel balancing machine with one end and engages inner threads of a supporting piece, which is securely connected to the tubular element, and a turning knob is provided on a part of a threaded spindle extending axially from the supporting piece.

5. Quick-clamping device as in claim 3, wherein:
a) the adjustment element includes an arresting element with the aid of which the conical assembly can be locked into different displacement positions.

6. Quick-clamping device as in claim 5, wherein:
a) the arresting element includes one of a radially spring-loaded ball and a spring-loaded rod, with a spherical end on one of the shaft and a component connected thereto, and the one of the ball and the spherical end of the spring-loaded rod is provided opposite respective arrest recesses in the tubular element.

7. Quick-clamping device as in claim 1, wherein:
a) the conical assembly is secured against rotation relative to the shaft.

8. Quick-clamping device as in claim 1, wherein:
a) the conical assembly includes an outer centering part with a cylindrical outer surface for engaging a centering hole of the vehicle wheel as well as a conical inner surface which the cone engages with its conical outer surface, and the outer centering part includes by two radially movable segments separated from one another.

9. Quick-clamping device as in claim 8, wherein:
a) the segments include radially extending guide parts, which are radially displaceably held in respective guides extending radially in the flange.

10. Quick-clamping device as in claim 9, wherein:
a) the guide parts have the shape of radial flange parts, which are guided in radial slots.

11. Quick-clamping device as in claim 10, wherein:
a) the radial slots are provided in the flange for receiving the rim of a vehicle wheel.

12. Quick-clamping device as in claim 8, wherein:
a) the segments are drawn radially inwardly by a spring element.

13. Quick-clamping device as in claim 12, wherein:
a) the spring element includes an elastic ring, which is housed in a peripheral groove of the segments.

14. Quick-clamping device as in claim 7, wherein:
a) an extension is provided which is configured to be secured to the shaft; and
b) the conical assembly is nonrotatably secured to the extension.

15. Quick-clamping device as in claim 1, wherein:
a) an extension is provided which is configured to be secured to the shaft; and
b) the extension has an outer wall abutting the clamping element for securing the rim of a vehicle against the flange.
